(19) United States
(12) Patent Application Publication
(10) Pub. No.: US 2017/0293038 A1
(43) Pub. Date: Oct. 12, 2017

(54) COMPACT RADIATION DETECTOR

(71) Applicant: SAINT-GOBAIN CERAMICS & PLASTICS, INC., Worcester, MA (US)

(72) Inventor: Peter R. MENGE, Novelty, OH (US)

(21) Appl. No.: 15/482,163

(22) Filed: Apr. 7, 2017

Related U.S. Application Data
(60) Provisional application No. 62/320,300, filed on Apr. 8, 2016.

(51) Int. Cl. G01T 1/20; G01T 1/202

(52) U.S. Cl. CPC G01T 1/2018; G01T 1/2023

(57) ABSTRACT

A dual mode radiation detector can include a compact casing, a scintillator; and a photosensor disposed on the scintillator. The scintillator can be the only detection medium disposed within the casing. The radiation detector can have a Pulse Shape Discrimination Figure of Merit of at least 1.5, or a neutron detection efficiency of at least 0.06 cps/ng ²⁵²Cf, measured at 1 meter with a 5 cm high density polyethylene moderator, each measured at a temperature of 22° C.

### CROSS-REFERENCE TO RELATED APPLICATION

This Application claims priority under 35 U.S.C. §119(e) to U.S. Provisional Application No. 62/320,300 entitled “COMPACT RADIATION DETECTOR,” by Peter R. MENGE, filed April 8, 2016, which is assigned to the current assignee hereof and is incorporated herein by reference in its entirety.

### FIELD OF THE DISCLOSURE

The present disclosure is directed to scintillators and methods of using such scintillators.

### BACKGROUND

Scintillator-based detectors are used in a variety of applications, including research in nuclear physics, oil exploration, field spectroscopy, container and baggage scanning, and medical diagnostics. When a scintillator material of the scintillator-based detector is exposed to ionizing radiation, the scintillator material absorbs energy of incoming radiation and scintillates, remitting the absorbed energy in the form of photons. A photosensor of the scintillator-based detector detects the emitted photons. Radiation detection apparatuses can analyze pulses for many different reasons. Continued improvements are desired.

### BRIEF DESCRIPTION OF THE DRAWINGS

Embodiments are illustrated by way of example and are not limited in the accompanying figures.

FIG. 1 includes an illustration of a radiation detector according to an embodiment described herein.

FIG. 2 includes a top view illustration of a detection medium according to an embodiment described herein.

FIG. 3 includes a top view illustration of a detection medium according to another embodiment described herein.

FIGS. 4A-4C include a depiction of a photosensor disposed on a detection medium according to embodiments described herein.

FIG. 5 includes an illustration of an analyzer device according to an embodiment described herein.

FIG. 6 includes plots of pulse shape discrimination parameter as a function of pulse height and counts.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the scintillation and radiation detection arts.

Compact, lightweight, hand-portable radiation detectors are desired for many nuclear security applications, such as including active search and passive monitoring for isotope identification and fissile material detection. A desirable instrument would combine a dual-mode detection material with a solid state read-out to create an extremely compact, power efficient, and easy-to-carry device.

In the description that follows is a dual mode radiation detector having the unexpected combination of compact size and excellent energy resolution for gammas, sensitivity to neutrons, and the ability to separate the two using pulse shape discrimination (PSD). In an embodiment, this combination can be achieved by a single detection medium having a thin sidewall and a particular placement of the photosensor on the detection medium, as will be described in more detail below. In another embodiment, this combination can result in a Pulse Shape Discrimination Figure of Merit of at least 1.5. The improved radiation detector will be described in more detail below.

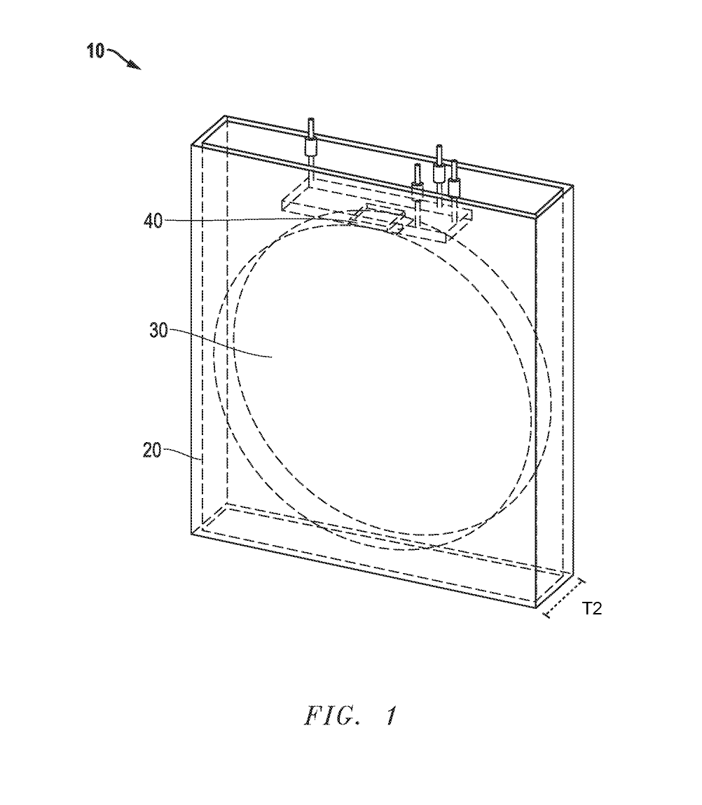

As illustrated in FIG. 1, the radiation detector 10 can include a casing 20, a detection medium 30 disposed within the casing 20, and a photosensor 40 disposed on the detection medium 30.

An advantage of the radiation detector described herein includes utilizing a single compact detection medium 30 to detect both neutrons and gamma radiation. In an embodiment, the detection medium 30 is the only detection medium disposed within the radiation detector.

In general, the detection medium 30 can have a thin sidewall so as to fit within the casing 20. For example, in an embodiment, the sidewall of the detection medium 30 can have a thickness T₁ of at most 10 mm, or at most 9 mm, at most 8 mm, or at most 7 mm. Although the radiation detector becomes more compact as the size of the detection medium decreases, the performance of the detection medium can deteriorate if the sidewall thickness becomes too small. In an embodiment, the sidewall of the detection medium 30 can have a thickness T₁ of at least 1 mm, or at least 2 mm, or at least 3 mm, or at least 4 mm. Further, the sidewall of the detection medium 30 can have a thickness T₁ in a range of any of the above minimum and maximum values, such as in a range of 1 to 10 mm, or 2 to 9 mm, or 3 to 8 mm, or 4 to 7 mm.

The sidewall of the detection medium 30 can define the perimeter of a major surface of the detection medium 30. In an embodiment, the major surface of the detection medium 30 can have a large width relative to the thickness T₁ of the sidewall. As used herein, the term “width” includes a diameter, such as when referring to an oval or a circle. In an embodiment, the detection medium 30 can have an aspect ratio of at least 5, or at least 6, or at least 7. As the aspect ratio increases, the performance and compact size of the detection medium 30 can be diminished. In an embodiment, the detection medium 30 can have an aspect ratio of at most 15, or at most 13, or at most 11. Moreover, the detection medium 30 can have an aspect ratio in a range of any of the above minimum and maximum values, such as 5 to 15, or 6 to 13, or 7 to 11. As used herein with respect to the radiation detection medium, the term “aspect ratio” refers to a ratio of the width of the major surface of the scintillator to the thickness of the sidewall of the scintillator.

In an embodiment, the major surface of the detection medium 30 can have a width of at least 40 mm, or at least 45 mm, or at least 50 mm. As the width of the major surface of the detection medium 30 increases, the aspect ratio increases and, as discussed above, as the aspect ratio increases, the performance and compact size of the detection medium 30 can be diminished. In an embodiment, the major surface of the detection medium 30 can have a width of at most 62 mm, or at most 60 mm, or at most 58 mm. Moreover, the major surface of the detection medium 30 can have a width in a range of 40 to 62 mm, or 45 to 60 mm, or 50 to 58 mm.

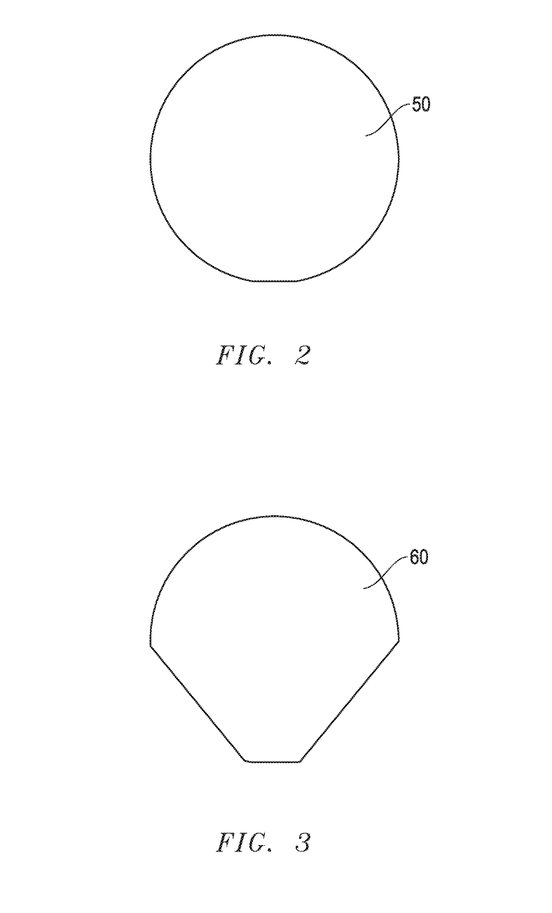

In an embodiment, the detection medium 30 can be a flat, thin detection medium. The detection medium 30 can have a generally arcuate shape. In an embodiment, the detection medium can have a disc shape. The radiation detector of any one of the preceding claims, wherein the scintillator is a scintillator disc. For example, the detection medium 30 can have a substantially circular (see FIG. 2) or oval shape. The shape can have a flat portion along the perimeter for placement of the photosensor and giving the major surface a single axis of symmetry. In another embodiment, as illustrated in FIG. 3, the major surface of the detection medium 30 can include an arcuate portion and a narrowing portion. Further, the narrowing portion can include opposing linear edges extending inwardly at an angle of at most 90° with respect to each other.

The photosensor 40 can receive photons emitted by the detection medium 30, and produce electronic pulses based on numbers of photons that it receives. The photosensor 40 can include a solid-state photosensor. In an embodiment, the solid-state photosensor can include a semiconductor-based photosensor. In a more particular embodiment, the photosensor 40 can include a silicon photomultiplier (SiPM).

While the width of the active area of the photosensor can be greater than the thickness of the sidewall of the detection medium, Applicants have discovered that the performance of the radiation detector can be greatly improved when the active area of the photosensor has a width that is at most equal to the thickness of the sidewall of the detection medium 30 and, even more so when the active area of the photosensor has a width that is less than the thickness of the sidewall of the detection medium. In an embodiment, the active area of the photosensor 40 has a width of at most 10 mm, at most 8 mm, or at most 6 mm. Of course, if the width of the active area of the photosensor 40 is too small, the performance advantage begins to deteriorate. In an embodiment, the active area of the photosensor has a width of at least 2 mm, or at least 3 mm, or at least 4 mm. Moreover, the active area of the photosensor 40 can have a width in a range of any of the above minimum and maximum values, such as 2 to 10 mm, or 3 to 8 mm, or 4 to 8 mm.

Further, the photosensor can have an area of at least 10 mm², or at least 15 mm², or at least 20 mm². The photosensor can have an area of at most 40 mm², or at most 38 mm², or at most 36 mm². The photosensor can have an area in a range of any of the above minimum and maximum values, such as in a range of 10 to 40 mm², or 25 to 38 mm², or 20 to 36 mm².

As opposed to, for example, a photomultiplier tube, that can be coupled to a detection medium indirectly via a light guide, the photosensor 40 can be disposed on the detection medium 30. For example, the photosensor 40 can be bonded, such as by an optical adhesive, to the detection medium 30. Further, Applicant has discovered that the performance of the radiation detector can be improved based on the location of the placement of the photosensor 40 on the detection medium 30. In general, a photosensor 40 can be disposed on at least one of the major surface of the detection medium 30 and on the sidewall of the detection medium 30. In an embodiment, a photosensor 40 is only disposed on the sidewall of the scintillator. In another embodiment, a photosensor 40 is only disposed on the major surface of the scintillator. In yet another embodiment, there is a plurality of photosensors 40 and at least one photosensor 40 is disposed on the sidewall of the detection medium and at least one photosensor 40 is disposed on the major surface of the detection medium 30. Applicants have discovered that each of the placement locations discussed above can provide suitable results for a dual mode detection medium. In addition, Applicants have discovered that performance can be more greatly improved when at least one photosensor 40 is placed on the sidewall of the detection medium 30 and, although it may add more complexity, even greater performance can be achieved when a photosensor 40 is disposed on both the sidewall and the major surface of the detection medium 30. Further, a plurality of photosensors 40 can be disposed on the sidewall of the detection medium 30. Furthermore, when the photosensor 40 is disposed on the major surface of the detection medium 30, the photosensor 40 can be disposed at the center of the major surface of the detection medium 30.

The detection medium 30 can include a scintillator material. In an embodiment, the scintillator material can include a crystalline inorganic scintillator material. In a particular embodiment, the scintillator material can include an elpasolite.

In an embodiment, the scintillator material can include an elpasolite has a general formula of: A_{(3-y)}B_{y} (RE)X₆, wherein: A and B are different alkali metals; RE is at least one rare earth; and X is at least one halogen; and 0<y<1.

As used herein, the rare earth elements include Sc, Y, La and the lanthanide series of elements.

In a particular embodiment, the scintillator comprises an elpasolite that includes Br, I, or combination thereof. In a more particular embodiment, the scintillator includes both Br and I. In another particular embodiment, Br or I makes up substantially all of the halide content within the elpasolite. Although not fully understood, Cs₂LiYCl₆:Ce (CLYC:Ce) is not as good for pulse shape discrimination between neutrons and gamma radiation at high temperatures, particularly above 120° C., as compared to Br-containing or I-containing elpasolites. Thus, in an embodiment, the scintillator has substantially no Cl. Furthermore, CLYC:Ce has core valance luminescence, and the core valence luminescence may interfere with the ability to discriminate between neutrons and gamma radiation. In another embodiment, the elpasolite has substantially no core valence luminescence generated by Cl.

In a further embodiment, the elpasolite includes at least two different rare earth elements. In a particular embodiment, the elpasolite comprises La, Ce, Pr, or any combination thereof. In still another embodiment, the elpasolite comprises at least two different Group 1 elements. One of the Group 1 elements may be larger than the other Group 1 element. In a particular embodiment, the scintillator comprises Cs, Rb, or any combination thereof, and in another particular embodiment, the scintillator comprises Li, Na, or any combination thereof.

In a more particular embodiment, the scintillator can include an elpasolite having a general formula a general formula of A_{(3-y)}Li_{y} (RE)X₆, where A is at least one of Na, K, Rb, and Cs; RE is at least one rare earth; where X is at least one halogen, and where 0<y<1.

In an embodiment, Li can be enriched with ⁶Li so that ⁶Li makes up more than 7% of the total Li content. In a particular embodiment, ⁶Li makes up at least 70%, at least 80%, or at least 90% of the total Li content. In another embodiment, the scintillator can include Li wherein ⁶Li makes up no greater than 7% of the total Li content. In one embodiment, the elpasolite has a stoichiometric composition, and in another embodiment, the elpasolite has a non-stoichiometric composition.

In a further embodiment, the scintillator is monocrystalline when the scintillator is a single crystal, as not all compositions in accordance with a general formula may be possible. For example, a particular composition may be monocrystalline when all of the halide content is Br or I or when Br makes up 30% of the total halide content, and I makes up 70% of the total halide content; however when Br makes up 30% of the total halide content, and I makes up 70% of the total halide content, the composition may have separate phases or form at least a partly polycrystalline scintillator. After reading this specification, skilled artisans will appreciate that phase diagrams for the particular compounds may be useful for determining particular starting materials and ratios of such starting materials.

In a particular embodiment, the scintillator has a general formula of: Cs₍₂₋₂ₓ₋₂ₘ₎Rb₍₂ₓ₎Na₍₂ₘ₎Li_{a(1-y)}Na_{(ay)}La_{b(1-u-v)}Ce_{(bu)}Pr_{(bv)}Br_{(2+a+3b)(1-z)}I_{(2+a+3b)z} wherein: each of x, m, y, u, v, and z has a value in a range of 0 to 1; and each of a and b has a value in a range 0.9 to 1.1.

With respect to the subscripts for a and b; a sum of subscripts for the halide anions can be adjusted to keep electroneutrality. A stoichiometric elpasolite composition corresponds to the above-referenced formula when a=1 and b=1.

In a more particular embodiment, the scintillator has a general formula of: Cs₂LiLa₍₁₋ᵤ₎Ce₍ᵤ₎Br₆ wherein 0.005≦u≦0.1.

In a further embodiment, u is at most 0.07, or at most 0.05, or at most 0.03.

As mentioned previously, the radiation detector 10 can include a compact casing. In an embodiment, the compact casing can have a sidewall having a thickness T₂, of at most 20 mm, or at most 16 mm, or at most 12 mm. In further embodiments, the casing can have an aperture within the values discussed above with respect to the aspect ratio of the detection medium. As used herein with respect to the casing, the term aspect ratio refers to the ratio of the width of a major surface of the casing to the sidewall thickness of the casing. The casing can have a shape to fit the desired application. In an embodiment, the casing can have a cuboidal shape having a major surface and a sidewall defining a perimeter of the major surface.

In an embodiment, the casing can have a major surface having a width of at most 70 mm, or at most 65 mm, or at most 60 mm. In an embodiment, the casing can have a major surface having a width of at least 40 mm, or at least 45mm, or at least 50 mm. Moreover, the casing can have major surface having in a range of any of the above minimum and maximum values discussed above, such as 40 to 70 mm, or 45 to 65 mm, or 50 to 60 mm.

In an embodiment, the casing can have a sidewall having a thickness of at least 6 mm, or at least 7 mm, or at least 8 mm. In an embodiment, the casing can have a sidewall having a thickness of at most 15 mm, or at most 13 mm, or at most 11 mm. Moreover, the casing can have a sidewall having a thickness in a range of any of the above minimum and maximum values, such as 6 to 15 mm, or 7 to 13 mm, or 8 to 11 mm.

Further, the detection medium 30 and the photosensor 40 can be contained within the casing 50. In an embodiment, the casing is a metal casing. In a more particular embodiment, the metal of the metal casing includes an aluminum. Further, the casing can be a hermetically sealed casing, as the detection medium can be a hygroscopic material.

In an embodiment, the radiation detector further comprises a foam layer disposed within the casing. The foam layer can support the detection medium and the photosensor within the casing. In the event that the scintillator and the photosensor are coupled to the casing with a hard contact or rigid coupling mechanism, shear forces between the scintillator and the photosensor may be sufficient to remove the photosensor from the scintillator. In certain embodiments, the scintillator and photosensor are free of any rigid coupling to the interior of the casing. Instead, the scintillator and the photosensor can be held by the foam layer within the casing and the photosensor can be coupled to the electrical output via flexible wires.

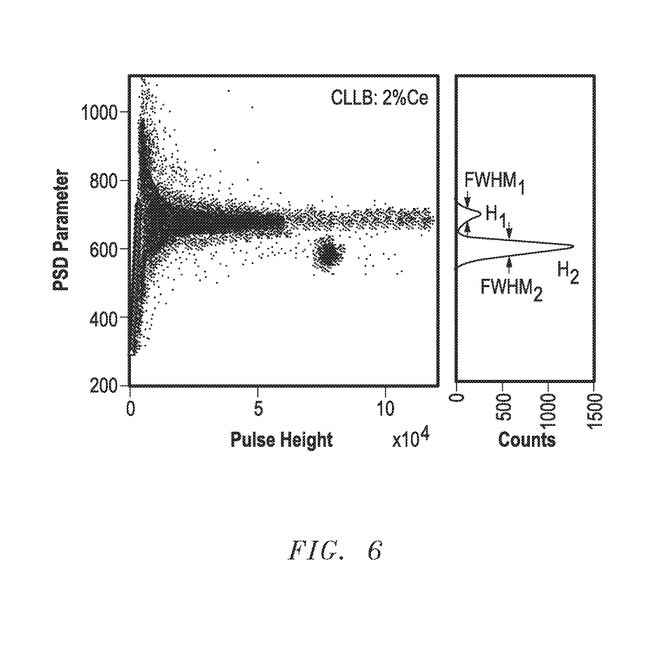

The casing can be suitable for electrical output. For example, as illustrated in FIG. 5, the photosensor 40 can be electrically coupled to an analyzer device 262. The analyzer device 262 can include hardware and can be at least partly implemented in software, firmware, or a combination thereof. In an embodiment, the hardware can include a plurality of circuits within an FPGA, an ASIC, another integrated circuit or on a printed circuit board, or another suitable device, or any combination thereof. The analyzer device 262 can also include a buffer to temporarily store data before the data are analyzed, written to storage, read, transmitted to another component or device, another suitable action is performed on the data, or any combination thereof.

In the embodiment illustrated in FIG. 5, the analyzer device 262 can include an amplifier 422 coupled to the photosensor 242, such that an electronic pulse from the photosensor 242 can be amplified before analysis. The amplifier 422 can be coupled to an analog-to-digital converter (ADC) 424 that can digitize the electronic pulse. The ADC 424 can be coupled to a pulse shape discrimination (PSD) module 442. In a particular embodiment, the PSD module 442 can include a FPGA or an ASIC. In a particular embodiment, the PSD module 442 can include circuits to analyze the shape of the electronic pulse and determine whether the electronic pulse corresponds to a neutron or gamma radiation. In a more particular embodiment, the PSD module 442 can use the electronic pulse and temperature from the temperature sensor 204 with a look-up table to determine whether the electronic pulse corresponds to a neutron or gamma radiation. The look-up table can be part of the FPGA or ASIC or may be in another device, such as an integrated circuit, a disk drive, or a suitable persistent memory device.

The analyzer device 262 further comprises a neutron counter 462 and a gamma radiation counter 464. If the PSD module 442 determines that an electronic pulse corresponds to a neutron, the PSD module 442 increments the neutron counter 462. If the PSD module 442 determines that an electronic pulse corresponds to gamma radiation, the PSD module 442 increments the gamma radiation counter 464.

An advantage of embodiments of the radiation detector described herein includes a compact radiation detector that has sufficiently different outputs between neutrons and gamma radiation to allow for pulse shape discrimination. Such a differentiation of outputs may be determined using the Pulse Shape Discrimination Figure of Merit (“PSD FOM”). In a particular embodiment, the scintillator with a composition of Cs₂LiLa_{0.98}Ce_{0.02}Br₆ (CLLB:2% Ce) is addressed to aid in understanding how Figure of Merit is determined. The scintillator is exposed to a neutron source, and the electronic pulse received by the analyzer device is processed using a fast Fourier transform to obtain a value for the PSD parameter. The PSD parameter may be determined by the time it takes for the electronic pulse to rise from 2% to 60% of its maximum intensity. Other integration ranges may be used for other scintillating compounds. For example, the PSD parameter may be determined by the time it takes for the electronic pulse to rise from 2% to 50% or 10% to 90% of its maximum intensity. FIG. 6 includes a plot of pulse height versus PSD parameter closer to the left-hand side of FIG. 6. As illustrated in FIG. 6, H₁ corresponds to the peak of the gamma radiation pulses, and H₂ corresponds to the peak of the thermal neutron pulses as illustrated in a plot closer to the right-hand side of FIG. 6. H₁ and H₂ expressed in units of PSD parameter using the Y-axis of the left-hand plot. Thus, H1 is 700 in units of the PSD parameter, and H₂ is 594 in units of the PSD parameter. A full width of half maximum (FWHM) can be obtained from the peaks in the right-hand plot and also be expressed in units of PSD parameter. FWHM₁ corresponds to the FWHM for H₁ and has a value of 37 units of the PSD parameter, and FWHM₂ corresponds to the FWHM for H₂ and has a value of 42 units of the PSD parameter.

As used herein, PSD FOM is defined by the following equation: |(H₁−H₂)|/(FWHM₁+FWHM₂).

H₁, H₂, FWHM₁, FWHM₂ are all in units of the PSD parameter, and therefore, PSD FOM is dimensionless. When PSD FOM is greater than 0, pulse shape discrimination can be used. As PSD FOM gets larger, PSD is more accurate and the possibility of pulse misclassification is reduced. As PSD FOM decreases, the PSD is more difficult and the possibility of pulse misclassification is increased. For the plot in FIG. 6, PSD FOM is 1.34. Therefore, CLLB:2% Ce has a PSD FOM of 1.34 for the temperature at which the data was collected. Other compositions can be analyzed is a similar manner. An advantage of embodiments of the radiation detector described herein includes a compact radiation detector that has an FOM of at least 1.5, or at least 1.6, or at least 1.7, or at least 1.8, or even at least 1.9, at a temperature of 22° C.

An advantage of embodiments of the radiation detector described herein includes a compact radiation detector with increased sensitivity. The sensitivity of a detector can be quantified by the energy resolution (Eᵣₑₛ), or the ability of the detector to accurately identify the energy of certain radiation. Typically, the resolution is quantified by determining full width half maximum (FWHM) values from a spectral curve (typically a Gaussian-shaped curve) for radiation striking the detector at a given energy. The smaller the FWHM value for a given spectral curve, the greater the energy resolution and accuracy of measurements. Exposure of a scintillation detector to elevated temperatures causes a decrease in the resolution that is detectable by an increase in the FWHM capabilities of the detector. The absolute energy resolution can be defined by the actual FWHM values. In an embodiment, the radiation detector has Eᵣₑₛ of at most 6.1%, or at most 5.9%, or at most 5.7%, or, in an embodiment where the shape of the scintillator has an arcuate portion and a narrowing portion (see FIG. 3), the energy resolution (Eᵣₑₛ) can be at most 5%, or at most 4.8%, or at most 4.6%, or at most 4.5%, at 1275 keV at 22° C.

Further regarding the improved sensitivity of the compact radiation detector described herein, the radiation detector can have a gamma rejection ratio of at most 1×10⁻⁷ false neutron detections per gamma ray detection over the range of 2.0 to 4.0 MeV gamma ray equivalent energy, measured at a temperature of 22° C. Furthermore, the radiation detector described herein can have a ¹³⁷Cs photopeak detection efficiency of at least 41, or at least 43, or at least 45 cps/(mCi· %), measured at 1 meter, measured at a temperature of 22° C. Moreover, the radiation detector can have a neutron detection efficiency of at least 0.04, or at least 0.05, or at least 0.06 cps/ng ²⁵²Cf, measured at 1 meter and moderated with 5 cm of high density polyethylene moderator, at a temperature of 22° C.

In addition, certain embodiments of the compact radiation detector described herein can achieve an improved light collection non-uniformity, such as a non-uniformity of at most 4%, or at most 3.5%, or at most 3%, measured at a temperature of 22° C.

The radiation detector described herein can be utilized for a variety of applications. In particular, due to its compact size, the radiation detector can be utilized as a handheld radiation detector.

Many different aspects and embodiments are possible. Some of those aspects and embodiments are described herein. After reading this specification, skilled artisans will appreciate that those aspects and embodiments are only illustrative and do not limit the scope of the present invention. Additionally, those skilled in the art will understand that some embodiments that include analog circuits can be similarly implement using digital circuits, and vice versa. Embodiments may be in accordance with any one or more of the items as listed below.

Embodiment 1. A dual mode radiation detector comprising: a casing having a sidewall thickness of at most 20 mm, a scintillator; and a photosensor disposed on the scintillator, wherein the scintillator is the only detection medium disposed within the casing.

Embodiment 2. A dual mode radiation detector comprising: a casing having a sidewall thickness of at most 20 mm; a scintillator disposed within the casing; and a photosensor disposed on the scintillator; wherein the radiation detector has a Pulse Shape Discrimination Figure of Merit of at least 1.5, measured at a temperature of 22° C.

Embodiment 3. A dual mode radiation detector comprising: a casing having a sidewall thickness of at most 20 mm; a scintillator disposed within the casing; and a photosensor disposed on the scintillator; wherein the radiation detector has a neutron detection efficiency of at least 0.06 cps/ng ²⁵²Cf, measured at 1 meter with a 5 cm high density polyethylene moderator, at a temperature of 22° C.

Embodiment 4. The radiation detector of any one of the preceding embodiments, wherein the scintillator comprises a sidewall and a major surface defined by the sidewall, and the photosensor is disposed on at least one of the major surface of the scintillator and the sidewall of the scintillator.

Embodiment 5. The radiation detector of embodiment 4, wherein the photosensor is only disposed on the sidewall of the scintillator.

Embodiment 6. The radiation detector of embodiment 4, wherein the photosensor is only disposed on the major surface of the scintillator.

Embodiment 7. The radiation detector of embodiment 4, wherein the radiation detector comprises a plurality of photosensors, and at least one photosensor is disposed on the sidewall of the scintillator and at least one photosensor is disposed on the major surface of the scintillator.

Embodiment 8. The radiation detector of any one of embodiments 4, 5, and 7, wherein the radiation detector includes a plurality of photosensors and at least two photosensors are disposed on the sidewall of the scintillator.

Embodiment 9. The radiation detector of any one of embodiments 4 and 6 to 8, wherein at least one photosensor is disposed on a center of the major surface of the scintillator.

Embodiment 10. The radiation detector of any one of embodiments 4 to 9, wherein the active area of the photosensor has a width that is less than or equal to a thickness of the sidewall of the scintillator.

Embodiment 11. The radiation detector of any one of the preceding embodiments, wherein an active area of the photosensor has a width of at most 10 mm, at most 8 mm, or at most 6 mm.

Embodiment 12. The radiation detector of any one of the preceding embodiments, wherein the photosensor has an active area of at most 40 mm², or at most 38 mm², or at most 36 mm.

Embodiment 13. The radiation detector of any one of the preceding embodiments, wherein the photosensor comprises a solid state photosensor.

Embodiment 14. The radiation detector of any one of the preceding embodiments, wherein the photosensor comprises a semi conductor-based photomultiplier.

Embodiment 15. The radiation detector of any one of the preceding embodiment, wherein the photosensor comprises a silicon-based photomultiplier.

Embodiment 16. The radiation detector of any one of the preceding embodiments, wherein the scintillator comprises an elpasolite.

Embodiment 17. The radiation detector of any one of the preceding embodiments, wherein the scintillator comprises an elpasolite having a general formula of A_{(3-y)}B_{y} (RE)X₆, wherein: A and B are different alkali metals; RE is at least one rare earth; and X is at least one halogen; and 0<y<1.

Embodiment 18. The radiation detector of any one of the preceding embodiments, wherein the scintillator comprises an elpasolite having a general formula a general formula of A_{(3-y)}Li_{y} (RE)X₆, where A is at least one of Na, K, Rb, and Cs; RE is at least one rare earth; where X is at least one halogen, and where 0<y<1.

Embodiment 19. The radiation detector of any one of the preceding embodiments, wherein the scintillator comprises an elpasolite having a general formula of Cs_{(3-y)}Li_{y}La₍₁₋ᵤ₎Ce₍ᵤ₎Br₆, where 0.005≦u≦0.1.

Embodiment 20. The radiation detector of embodiment 19, wherein u is at most 0.07, or at most 0.05, or at most 0.03.

Embodiment 21. The radiation detector of any one of embodiments 4 to 20, wherein the sidewall of the scintillator has a thickness of at most 10 mm, or at most 9 mm, at most 8 mm, or at most 7 mm.

Embodiment 22. The radiation detector of any one of embodiments 4 to 21, wherein the major surface of the scintillator has a width of at most 62 mm, at most 60 mm, or at most 58 mm.

Embodiment 23. The radiation detector of any one of embodiments 4 to 20, wherein the scintillator has an aspect ratio of at least 5, or at least 6, or at least 7, wherein the aspect ratio is a ratio of the width of the major surface of the scintillator to the thickness of the sidewall of the scintillator.

Embodiment 24. The radiation detector of any one of the preceding embodiments, wherein the scintillator is a scintillator disc.

Embodiment 25. The radiation detector of any one of the preceding embodiments, wherein the scintillator is a flat scintillator.

Embodiment 26. The radiation detector of any one of the preceding embodiments, wherein the major surface of the scintillator has an arcuate shape.

Embodiment 27. The radiation detector of any one of the preceding embodiments, wherein the major surface has a substantially circular shape.

Embodiment 28. The radiation detector of any one of the preceding embodiments, wherein the major surface has a single axis of symmetry.

Embodiment 29. The radiation detector of any one of embodiments 1 to 26 and 28, wherein the major surface includes an arcuate portion and a narrowing portion.

Embodiment 30. The radiation detector of embodiment 29, wherein the narrowing portion includes opposing linear edges extending inwardly at an angle of at most 90° with respect to each other.

Embodiment 31. The radiation detector of any one of embodiments 2 to 30, wherein the scintillator is the only detection medium disposed within the radiation detector.

Embodiment 32. The radiation detector of any one of embodiments 29 and 30, wherein the radiation detector has an energy resolution (Eᵣₑₛ) of at most 5%, or at most 4.8%, or at most 4.6%, or at most 4.5% at 1275 keV.

Embodiment 33. The radiation detector of any one of embodiments 1 to 31, wherein the radiation detector has an energy resolution (Eᵣₑₛ) of at most 6.1%, or at most 5.9%, or at most 5.7% at 1275 keV.

Embodiment 34. The radiation detector of any one of the preceding embodiments, wherein the radiation detector has a gamma rejection ratio of at most 1×10⁻⁷ false neutron detections per gamma ray detection over the range of 2.0 to 4.0 MeV gamma ray equivalent energy, measured at a temperature of 22° C.

Embodiment 35. The radiation detector of any one of the preceding embodiments, wherein the radiation detector has a light collection non-uniformity of at most 4%, or at most 3.5%, or at most 3%, measured at a temperature of 22° C.

Embodiment 36. The radiation detector of any one of the preceding embodiments, wherein the radiation detector has a ¹³⁷Cs photopeak detection efficiency of at least 41, or at least 43, or at least 45 cps/(mCi· %), measured at 1 meter, at a temperature of 22° C.

Embodiment 37. The radiation detector of any one of the preceding embodiments, wherein the radiation detector has a neutron detection efficiency of at least 0.04, or at least 0.05, or at least 0.06 cps/ng ²⁵²Cf, measured at 1 meter with a 5 cm high density polyethylene moderator, at a temperature of 22° C.

Embodiment 38. The radiation detector of any one of the preceding embodiments, wherein the casing comprises a metal casing.

Embodiment 39. The radiation detector of embodiment 38, wherein the casing comprises an aluminum.

Embodiment 40. The radiation detector of any one of the preceding embodiments, wherein the casing comprises a hermetically sealed casing.

Embodiment 41. The radiation detector of any one of the preceding embodiments, wherein the casing has a major surface having a width of at most 70 mm, or at most 65 mm, or at most 60 mm.

Embodiment 42. The radiation detector of any one of the preceding embodiments, wherein the casing has a sidewall having a thickness of at most 15 mm, or at most 13 mm, or at most 11 mm.

Embodiment 43. The radiation detector of any one of the preceding embodiments, wherein the casing is suitable for electrical output.

Embodiment 44. The radiation detector of any one of the preceding embodiments, further comprising a foam layer disposed within the casing.

Embodiment 45. The radiation detector of any one of the preceding embodiments, wherein the scintillator and photosensor are disposed within the casing free of any rigid coupling to an interior of the casing.

Embodiment 46. The radiation detector of any one of the preceding embodiments, wherein the radiation detector is a handheld radiation detector.

### EXAMPLES

The Examples are given by way of illustration only and do not limit the scope of the present invention as defined in the appended claims. All scintillators were exposed to ²⁵²Cf having a mass of approximately 109 nanogram and placed about 30 cm from the scintillator. The exposure was performed at about 22° C. Radiation captured by the scintillators caused scintillating light to be emitted that was collected by a photosensor, which in turn generated an electronic pulse.

### Example 1

Scintillator performance data was collected on three scintillator compounds, Sample 1, Sample 2, and Sample 3, each having the formula Cs₂LiLa_{0.98}Ce_{0.02}Br₆ (CLLB:2%Ce). Each sample had a circular shape with a diameter of about 54 mm. The thicknesses of the three samples were sequentially reduced as set forth in Table 1. The results of the scintillator performance testing are also provided in Table 1.

TABLE 1

| | | Eᵣₑₛ at | Relative Light | PSD |
|---|---|---|---|---|
| Sample | Thickness | 1275 keV | Output | FOM |
| 1 | 10 mm | 5.61% | 0.89 | 1.81 |
| 2 | 6 mm | 5.02% | 1.00 | 1.79 |
| 3 | 4 mm | 5.08% | 0.98 | 1.70 |

Based on the data collected, a geometrically matched detection medium and photosensor, Sample 2, has the best resolution and light output of the three samples. Surprisingly, the scintillator having a reduced thickness relative to the photosensor, Sample 3, achieved a better resolution and light output than the scintillator having an increased thickness relative to the photosensor, Sample 1, achieved a better PSD FOM.

### Example 2

Scintillator performance data was collected on two scintillator compounds, Sample 4 and Sample 5, each having the formula Cs₂LiLa_{0.98}Ce_{0.02}Br₆ (CLLB:2% Ce). Sample 1 had the same thickness (about 6 mm) and maximum diameter (about 54 mm). However, Sample 4 had a generally circular shape 50, as illustrated in FIG. 2, whereas Sample 5 had a shape 60 including an arcuate portion and a narrowing portion, as illustrated in FIG. 3. Sample 4 had an Eᵣₑₛ of 5.0% and Sample 5 had an E, of 4.5%. Based on the data, both shapes achieve improved resolution, while the shape of Sample 5 improves resolution by about 0.5%.

### Example 3

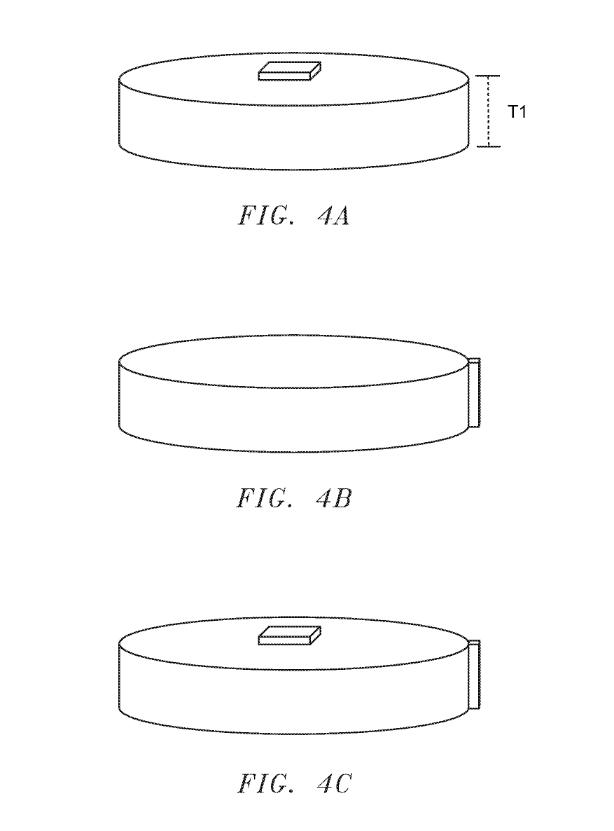

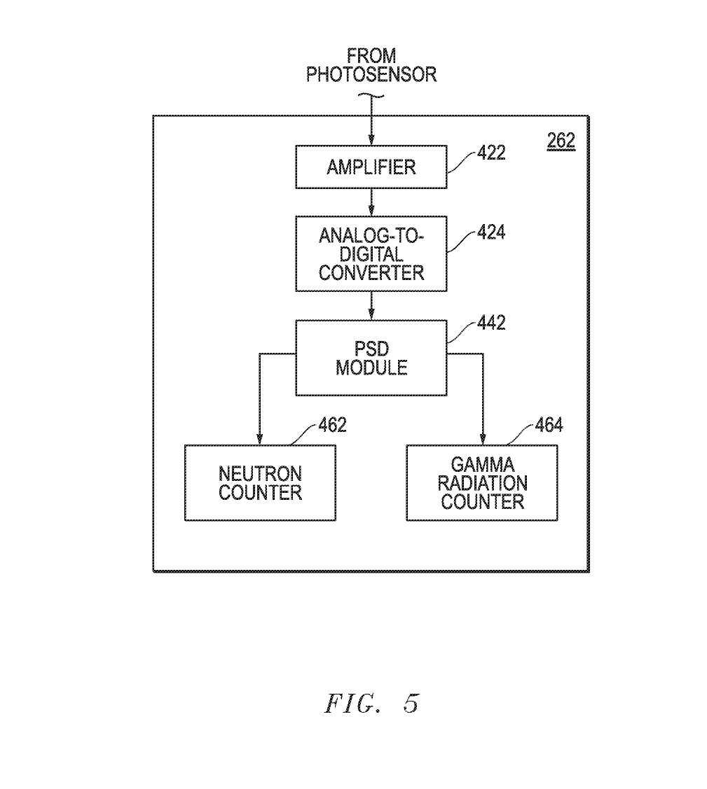

Scintillator performance data was collected on three scintillator compounds, Sample 6, Sample 7, and Sample 8, each having the formula Cs₂LiLa_{0.98}Ce_{0.02}Br₆ (CLLB:2% Ce). Each of the samples had a substantially circular shape and the same thickness (about 6 mm) and maximum diameter (about 52 mm). However, as illustrated in FIG. 4, Sample 6 had a 6×6 mm² SiPM disposed only at the center of the major surface of the scintillator (see “a”), Sample 7 had a 6×6 mm² SiPM disposed only on the sidewall of the scintillator (see “b”), and Sample 8 had a 6×6 mm² SiPM disposed both at the center of the major surface of the scintillator and on the sidewall of the scintillator (see “c”). The results of the scintillator performance testing is provided in Table 2.

TABLE 2

| | Simulated Light Collection | Eᵣₑₛ at 1275 keV |
|---|---|---|
| Sample | Non-uniformitiy | at 22° C. |
| 6 | 3.2% | 6.0 |
| 7 | 2.6% | 5.0 |
| 8 | 2.1% | 4.8 |

While all achieve suitable uniformity and resolution, having an SiPM disposed on the sidewall, Samples 7 and 8, achieve improved performance over Sample 6.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Certain features, that are for clarity, described herein in the context of separate embodiments, may also be provided in combination in a single embodiment. Conversely, various features that are, for brevity, described in the context of a single embodiment, may also be provided separately or in a subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A dual mode radiation detector comprising:
a casing having a sidewall thickness of at most 20 mm,
a scintillator; and
a photosensor disposed on the scintillator,
wherein the scintillator is the only detection medium disposed within the casing.

2. The radiation detector of claim 1, wherein the scintillator comprises a sidewall and a major surface defined by the sidewall, and wherein the photosensor is disposed on at least one of the major surface of the scintillator and the sidewall of the scintillator.

3. The radiation detector of claim 2, wherein the photosensor is only disposed on the sidewall of the scintillator.

4. The radiation detector of claim 2, wherein the photosensor is only disposed on the major surface of the scintillator.

5. The radiation detector of claim 2, wherein the radiation detector comprises a plurality of photosensors, and at least one photosensor is disposed on the sidewall of the scintillator and at least one photosensor is disposed on the major surface of the scintillator.

6. The radiation detector of claim 2, wherein the radiation detector includes a plurality of photosensors and at least two photosensors are disposed on the sidewall of the scintillator.

7. The radiation detector of claim 2, wherein at least one photosensor is disposed on a center of the major surface of the scintillator.

8. The radiation detector of claim 2, wherein an active area of the photosensor has a width that is less than or equal to a thickness of the sidewall of the scintillator.

9. The radiation detector of claim 1, wherein the photosensor comprises a solid state photosensor.

10. The radiation detector of claim 1, wherein the scintillator comprises an elpasolite.

11. The radiation detector of claim 1, wherein the scintillator comprises an elpasolite having a general formula of A_{(3-y)}B_{y} (RE)X₆, wherein:
A and B are different alkali metals;
RE is at least one rare earth; and
X is at least one halogen; and
0<y<1.

12. The radiation detector of claim 2, wherein the major surface of the scintillator has an arcuate shape.

13. The radiation detector of claim 2, wherein the major surface has a substantially circular shape.

14. The radiation detector of claim 2, wherein the major surface has a single axis of symmetry.

15. The radiation detector of claim 2, wherein the major surface includes an arcuate portion and a narrowing portion.

16. The radiation detector of claim 2, wherein the narrowing portion includes opposing linear edges extending inwardly at an angle of at most 90° with respect to each other.

17. The radiation detector of claim 1, wherein the scintillator and photosensor are disposed within the casing free of any rigid coupling to an interior of the casing.

18. The radiation detector of claim 1, wherein the radiation detector is a handheld radiation detector.

19. A dual mode radiation detector comprising:
a casing having a sidewall thickness of at most 20 mm;
a scintillator disposed within the casing; and
a photosensor disposed on the scintillator;
wherein the radiation detector has a Pulse Shape Discrimination Figure of Merit of at least 1.5, measured at a temperature of 22° C.

20. A dual mode radiation detector comprising:
a casing having a sidewall thickness of at most 20 mm;
a scintillator disposed within the casing; and
a photosensor disposed on the scintillator;
wherein the radiation detector has a neutron detection efficiency of at least 0.06 cps/ng ²⁵²Cf, measured at 1 meter with a 5 cm high density polyethylene moderator, at a temperature of 22° C.
